(19) United States
(12) Patent Application Publication
(10) Pub. No.: US 2004/0126565 A1
(43) Pub. Date: Jul. 1, 2004

(54) Actively controlled impact elements

(76) Inventors: Ganapathy Naganathan, Maumee, OH (US); Sheila L Vieira, Villa Rica, GA (US)

Correspondence Address: EMCH, SCHAFFER, SCHAUB & PORCELLO CO, P O BOX 916, ONE SEAGATE SUITE 1980, TOLEDO, OH, 43697

(21) Appl. No.: 10/474,989

(22) PCT Filed: May 9, 2002
(86) PCT No.: PCT/US02/14782

(51) Int. Cl. B32B 5/16

(52) U.S. Cl. 428/323; 428/328

(57) ABSTRACT

A magnetorheological (MR) elastomeric composite (10) includes an elastomeric matrix material (11) and a plurality of MR elements (12) composed of a shaped MR material elastomer (14) with polarizable/magnetizable particles and at least one electrically conducting material (13) wound around at least one MR shaped material. The electrically conducting material-wound element is embedded in the elastomeric matrix material. The magnetorheological composite undergoes changes in modulus when the MR element is subjected to a magnetic field.

### TECHNICAL FIELD

This invention relates small cross section, magnetorheological elastomeric elements useful as impact absorbing elements which are actively controlled in applications such as bumpers, car doors, suspensions and any part of other machine and device or systems that can use a damping system or a damping suspension.

### BACKGROUND OF THE INVENTION

Certain fluids when exposed to magnetic fields show a remarkable change in their rheological behavior. These materials have a great potential in many applications such as, for example, torque transfer devices, damping systems, and brakes. This family of magnetic field-dependent materials includes ferrofluids, magnetic powders, magnetorheological fluids and magnetorheological elastomers.

Magnetorheological (MR) fluids are non-colloidal suspensions of micrometer-sized magnetizable particles suspended in non-magnetic liquids. The magnetorheological response of MR fluids results from the polarization induced in the suspended particles by the application of an external field which induces a dipole moment in each of the suspended particles. As the dipole-dipole interaction between the particles increases and overcomes the thermal energy, the particles align to form chains along the field lines. A further increase of the magnetic field causes the aggregation of these chains into columnar structures, parallel to the applied field. These chain-like structures restrict the motion of the fluid, thereby increasing the viscous characteristics of the suspension. In this condition, these MR fluids show yielding properties and their yield stress ρ_{y} (minimum stress necessary for initiating flow) is a function of the applied field strength.

Magnetorheological elastomers are the solid-state analogues of MR fluids, which are obtained by suspending micrometer size magnetizable particles in a viscoelastic solid such as an elastomer. The physical phenomena responsible for the field sensitivity of these elastomers are very similar to MR fluids. The difference, however, is that the particle chains within the elastomer composite are intended to operate in the pre-yield region while the field MR fluids typically operate within a post-yield continuous shear flow. The strength of MR elastomers is characterized by their field dependent-modulus, while MR fluids are characterized by their field-dependent yield stress.

Magnetic fields are applied to the MR elastomer during crosslinking such that particle chain structures form and become locked in place upon final cure. This processing is used to impart special anisotropic properties on viscoelastic materials. Only recently has the field responsiveness of the viscoelastic properties of these elastomers been explored. The formation of columnar particle structures within elastomers corresponds to a low dipolar energy state. Shearing of the cured composite in the presence of the field causes particle displacement from this low energy state, thereby, requiring additional work. In principle, this required additional work increases monotonically with the volume percentage of iron on the elastomer and with the applied magnetic field, thus resulting in a field dependent shear modulus.

Bossis G., Abbo C., Cutillas, S., Lacis S. and Métayer C., (2000) Electroactive and Electrostructured Elastomer. 7^{th} Int. Conference on Electrorheological (ER) Fluids and Magneto-Rheological (MR) Suspensions, ed. R. Tao, World Scientific, pp. 18-27, studied the behavior of an elastomer matrix made from a bi-component silicone filled with particles made of carbonyl iron. Two types of samples were tested: isotropic (particles were mechanically dispersed in the prepolymer and the blend was poured into a cylindrical mold before curing took place) and structured (a magnetic field was applied during the curing process in order to align the magnetic particles in the direction of the field). The structured MR elastomer sample showed a better performance than the isotropic sample.

Ginder, J. M., Nichols, M. E., Elie, L. D. and Clark, S. M., (2000) Controllable-Stiffness Components Based on Magnetorheological Elastomers. Smart Structures and Materials 2000: Smart Structures and Integrated Systems, editor Norman Wereley, Proceedings of SPIE, vol. 3985, pp. 418-425, described the response of tunable automotive bushings and mounts (incorporating MR elastomers) due to dynamic mechanical loading.

Ginder et al. U.S. Pat. No. 5,549,837 discloses magnetic fluid based magnetorheological fluids.

Carlson, J. D. and Jolly, M. R. (2000), MR Fluid, Foam and Elastomer Devices. Mechatronics, 10 pp. 555-569, discussed magnetorheological elastomers and changes in the elastic modulus of MR elastomers containing different percentages of iron particles as a function of the composite flux density.

Nichols et al. U.S. Pat. No. 5,607,996 and EP 0706 189 A1, disclose electrorheological elastomers where an electrical field is applied to an elastomer composition comprising rubber and polarizable particles.

The EP 0784 163 A1 described a variable stiffness bushing using magnetorheological elastomers where a MR elastomer is positioned between inner and outer steel annular elements.

MR elastomers have many advantages when compared to MR fluids, such as no susceptibility to gravitational settling and no leakage. As such, there has been a great interest in applying the MR technology to automotive applications such as primary suspension, secondary suspension, engine mounts and the like. The increasing interest and research on MR fluids and elastomers have led to newer fields of applications. However, in order for this MR technology to be employed successfully, the prime requirements are low power consumption with high performance of the MR fluid/elastomer, low weight of the system, reduced package volume and low cost to manufacture the system.

A major contributor to the above size and weight concerns is the required coil technology to apply the magnetic field in the current approach. The large cross-section of the MR fluid/elastomer geometries requires larger field and heavy electromagnetic windings or permanent magnet.

### DESCRIPTION OF THE FIGURES

FIG. 1 is a schematic illustration showing a top view of a magnetorheological elastomer composite.

FIG. 2 is an enlarged view of the illustration in FIG. 1.

FIG. 3 is a schematic view of a magnetorheological elastomer composite connected to a supply of electrical current.

FIG. 4A is a cross-sectional view of one embodiment of a magnetorheological elastomer composite.

FIG. 4B is a cross-sectional view of another embodiment of a magnetorheological elastomer composite.

FIG. 5 is a schematic view of a flow diagram showing one method for making a magnetorheological elastomer composite.

FIG. 6 is a schematic view of a flow diagram showing another method for making of a magnetorheological elastomer composite.

FIG. 7 is a schematic view of a flow diagram showing yet another method for making a magnetorheological elastomer composite.

### DESCRIPTION OF THE PREFERRED EMBODIMENT

The invention comprises a composite made of at least one elastomeric matrix material and at least one magnetorheological (MR) elastomer element. The MR elastomer element comprises at least one suitable elastomeric material embedded with a smaller cross-section geometry having a plurality of magnetorheological particles dispersed therein and at least one electrically conducting material through which a current can flow. In certain embodiments, the MR elastomeric material of the MR element can have a predetermined desired shape. The electrically conducting material is at least partially wound around the shaped elastomeric material. It should be understood that the MR elastomeric material comprising the MR elastomer element can have any suitable shape, such as, for example, a cylindrical shape, and that for ease of illustration and discussion herein, such MR elastomeric material will be described as a shaped MR material. The cross-section of the shaped MR material geometry is designed (typically small) in order to minimize the weight of the magnetic field generator. In certain embodiments, the electrically conducting material can be a wire and in certain embodiments the wire can have a wound or braided arrangement. For ease of illustration and discussion herein such electrically conducting material will generally be referred to as a wire.

The elastomeric matrix composition and the elastomeric material comprising the shaped MR material can be any suitable elastomeric material. In certain embodiments, the elastomeric matrix material and the shaped MR material can be comprised of the same elastomeric material. In such embodiments, it should be understood that the “shaped” material will be defined as that material that is within the coiled or wound electrically conducting material. In such embodiments, the shaped material and the matrix material may be readily bonded or cured together or assembled separately.

In certain other embodiments, the elastomeric matrix material and the shaped MR material can be comprised of different elastomeric materials.

Upon application of a current in the wire, a magnetic field is induced inside the shaped MR element. The shaped MR element undergoes changes in its modulus, which changes the apparent stiffness of the whole MR composite. This stiffness is controlled by the intensity of the applied magnetic field.

The shaped MR elements are comprised of any suitable elastomeric material having a suitable amount of magnetic/polarizable particles dispersed within the elastomeric material. The shaped MR element has desired mechanical properties which properties are modulated by means of an applied magnetic field. The shaped MR elements are subjected to magnetic fields generated by an electrical current passing through the coiled wire.

It is also within the contemplated scope of the present invention that a suitable amount of polarizable/magnetizable particles can be additionally dispersed within the elastomeric matrix composite.

The lightweight, low cost and practical MR composite has improved non-linear or variable stiffness. The stiffness is variably adjusted, or controlled, over a wide range of values by controlling the magnetic field within the shaped MR material. In applications where the MR composite is used in an automotive system, the current can be supplied from the automotive electrical system. For example, the MR composite of the present invention is particularly useful for controlling the vibration, or relative displacement, of adjacent components. It is to be understood that while the present invention is described in particular with relation to automobile applications, the present invention is also useful in other applications where it is desired to actively control the stiffness of the composite, including, for example, exercise equipment and the like.

In certain embodiments, the matrix material has a plurality of shaped MR elements disposed within the elastomeric matrix material at predetermined spaced apart intervals.

Suitable amounts of electrical current are applied to the wires to generate a variable magnetic field in the shaped MR elements. The magnetic field causes the MR elastomer to have changes in its material properties resulting in changes in apparent stiffness of the MR composite. In certain end use applications, changes in these properties are, in turn, used to control or adjust the relative displacement of the adjacent structures of the end use application (for example, automobile) in response to preset conditions such as engine speed, vehicle speed and the like.

It is within the contemplated scope of the present invention that various suitable elastomeric/polymer gel materials can be used. For example, suitable elastomeric materials can be chosen for desirable characteristics such as, handling capabilities, temperature resistance properties, and/or durability. In certain embodiments, the elastomers may comprise a suitable gel or an elastomer of natural rubber, silicone, polybutadiene, polyethylene, styrene butadiene rubber (SBR), nitrile rubber, polychloroprene, polyisobutylene, synthetic polyisoprene, and blends thereof.

In certain embodiments, the particles in the MR elastomeric material are polarizable or magnetizable by means of an applied magnetic field. The particles have paramagnetic, ferrimagnetic, or ferromagnetic properties. Examples of preferred paramagnetic particles include oxides, chlorides, sulfates, sulfides, hydrates, and other organic or inorganic compounds of cerium, chromium, cobalt, dysprosium, erbium, europium, gadolinium, holmium, iron, manganese, neodymium, nickel, praseodymium, samarium, terbium, titanium, uranium, vanadium, and yttrium. In certain embodiments, preferred paramagnetic elements and alloys include gadolinium, various stainless steels and other alloys of iron, nickel, manganese, and cobalt, with or without other non-magnetic elements. In other embodiments, ferrimagnetic particulates include magnetite (Fe₃O₄) and other compounds of iron and oxygen, and a third metallic component. Ferromagnetic materials include iron, nickel, and cobalt, as well as alloys of these and other materials. Also, any combination of such magnetizable materials can be used in the present invention.

The size of the magnetizable particles used within the compositions can vary widely, such as, for example, from about 0.1 nanometers to about 100 micrometers. The particles can comprise up to about 40%, by volume, of the shaped MR material.

The MR elastomeric material can be made by using either a liquid or a solid precursor that is substantially uniformly mixed with the magnetizable particles, and processed into its final solid form using any suitable processing including, for example, chemical, thermal, optical, electrical, or other treatments or processes.

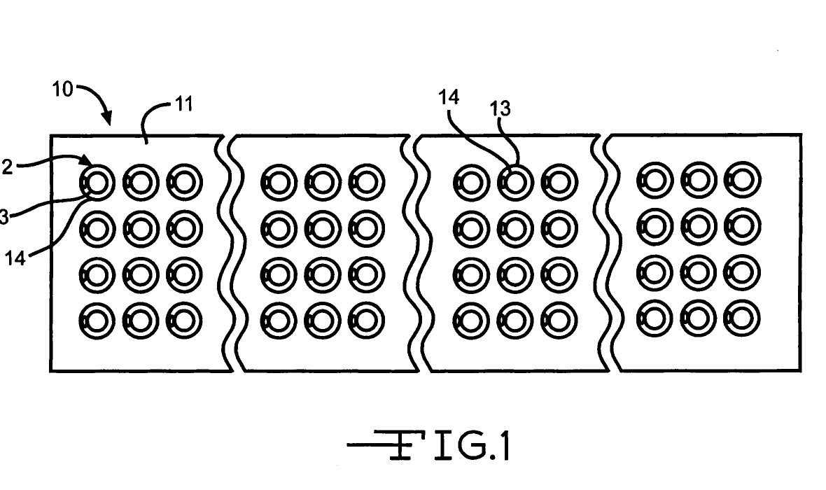

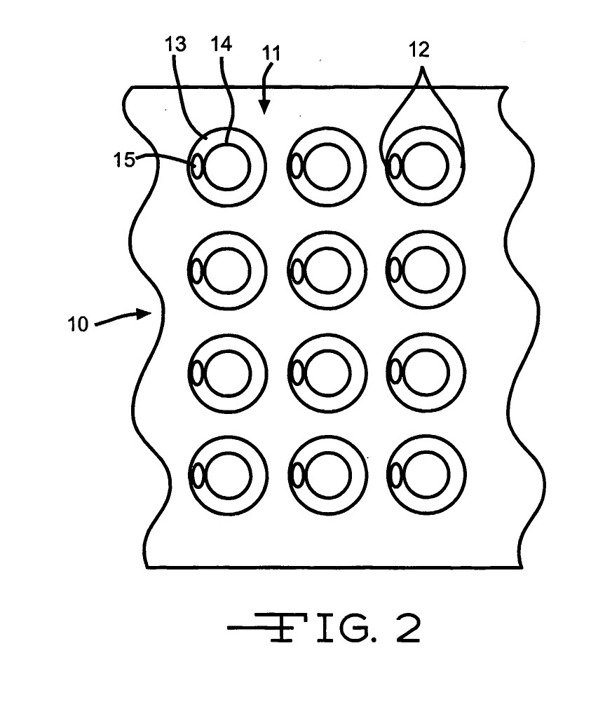

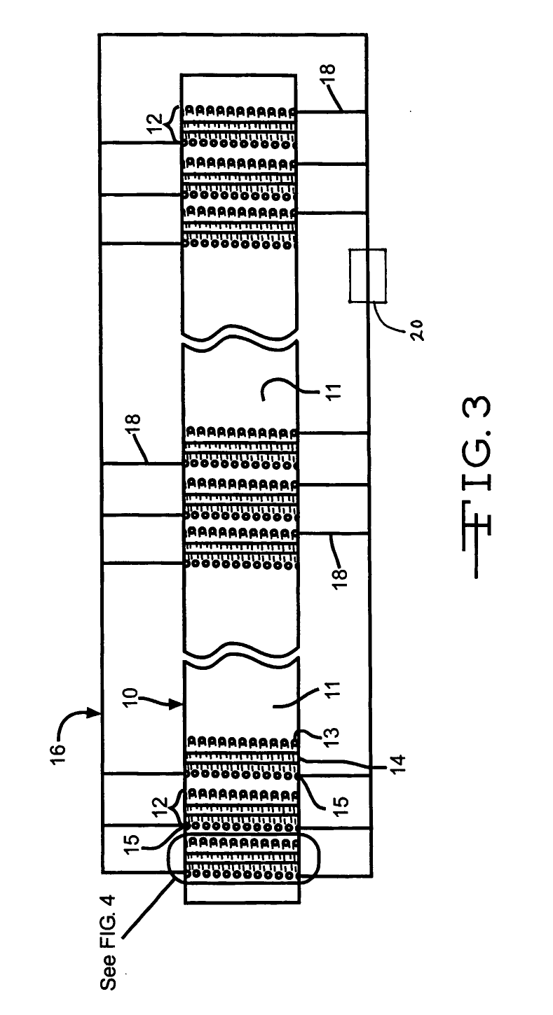

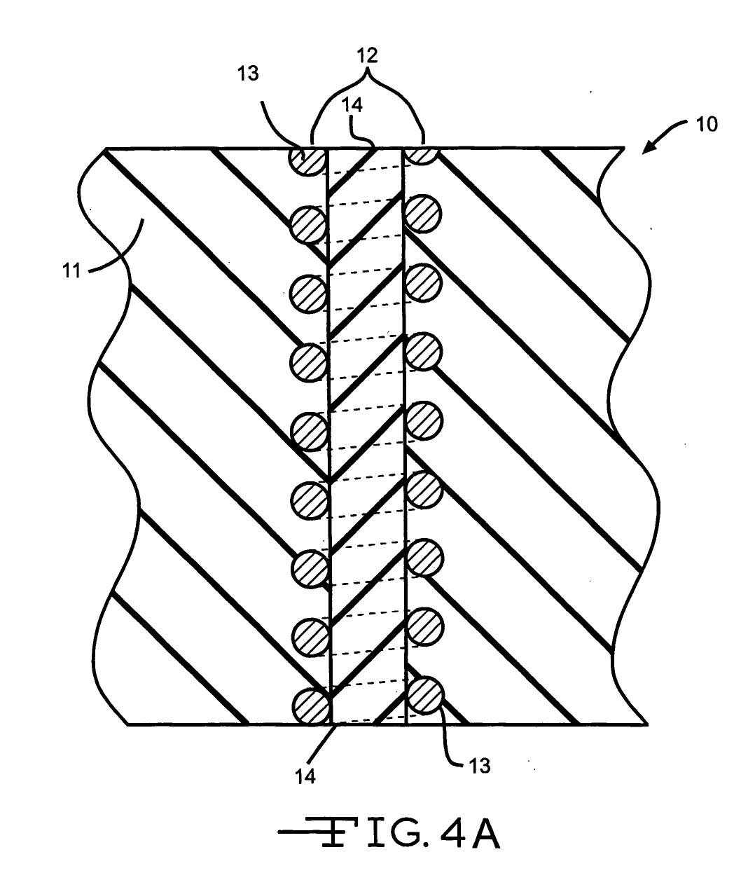

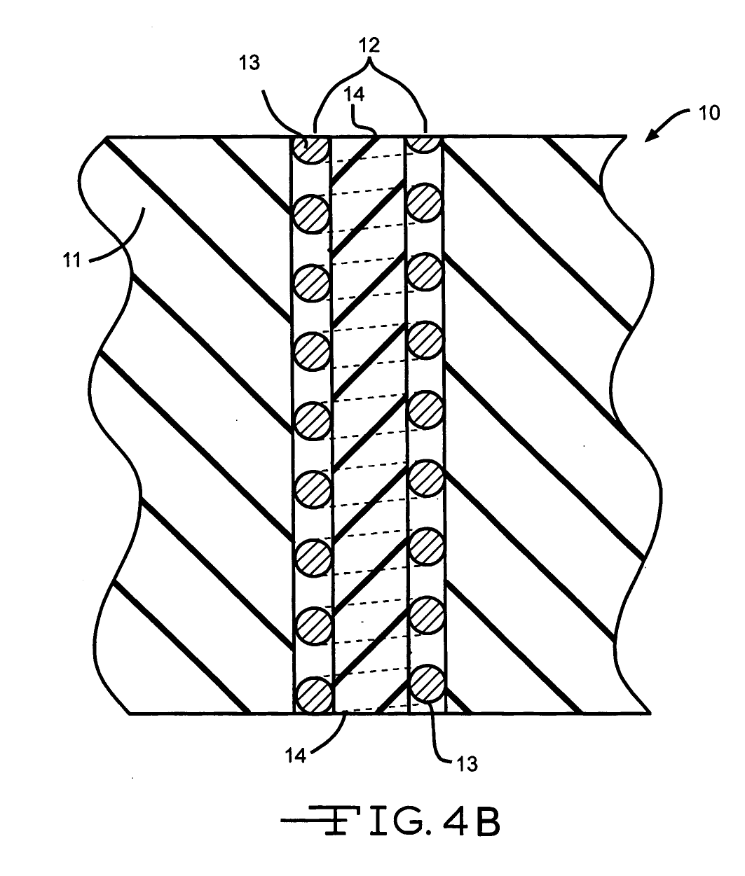

Referring now to the FIGS. 1 to 4, schematic views are shown of a magnetorheological composite 10 comprised of a suitable elastomeric matrix material 11 and a plurality of MR elements 12. The MR element 12 comprises a suitable shaped MR elastomeric material 14, as described above, shown here having a cylindrical shape, and a material capable of conducting electricity, such as wire material 13. The conducting material 13 is wound around the shaped MR material 14. The conducting material 13 is made of any suitable electrical material that conducts electricity. Examples of suitable electrical materials include, for example, conducting and semi- conducting materials, including for example semi-conducting organic polymers, and inorganic semi-conducting materials and metal oxide compounds. In certain embodiments, the electric conducting wire 13 has a direct current electrical conductivity typically of about 4×10⁶ to 3×10⁷ (Ω·m)⁻¹. In other embodiments, the electrically conducting material can be operatively connected to an alternating current, or power supply 20. The conducting material 13 is operatively connected at each end 15 to a suitable power grid 16 which includes a plurality of connecting materials 18 and a power supply 20.

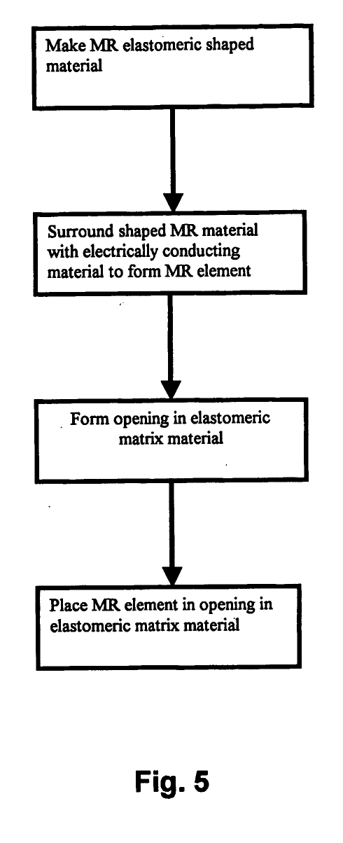

FIG. 5 shows one embodiment of a method of making of the MR elastomeric composite 10. At least one suitable precursor MR elastomeric material composition (comprising at least one type of elastomeric material and at least one type of magnetizable particles) is formed into a suitably shaped MR material 14. The electrically conducting material 13 is at least partially wound or coiled around the shaped MR material 14 to form the MR element 12. In certain processes the MR element 12 is exposed to a desired treatment or process in order to align the magnetic particles within the MR elastomeric material. The MR element 12 is then positioned within an opening in the elastomeric matrix material 11.

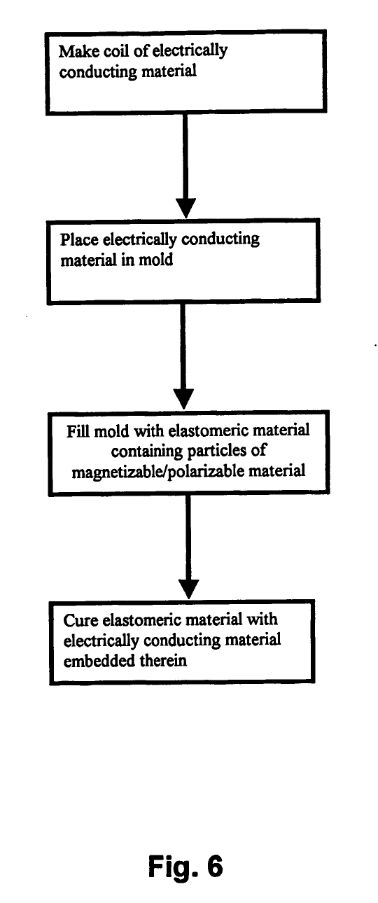

Another embodiment of a method of making the MR composite 10 is shown in FIG. 6. The electrically conducting material 13 is formed into a coil. The coiled electrically conducting material 13 is placed in a suitable mold which has desired dimensions. The mold is filled with a suitable elastomeric material containing particles of magnetizable/polarizable material. The elastomeric material with the coiled electrically conducting material 13 is cured, thereby embedding the coiled material 13 within the elastomeric material.

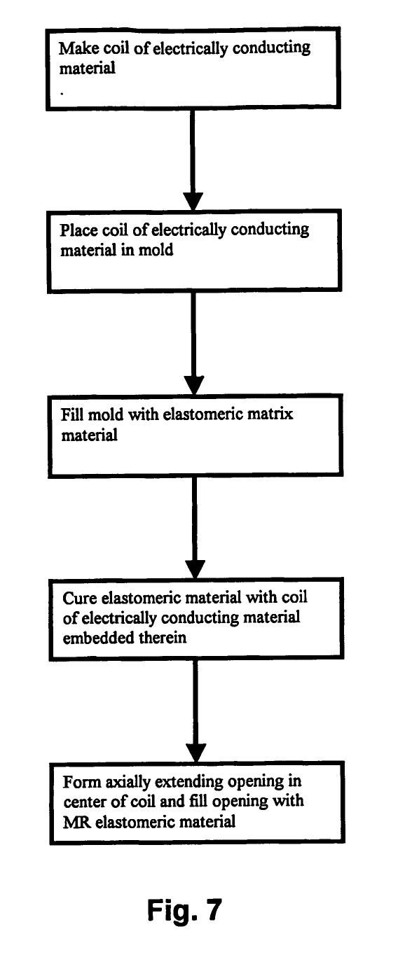

In yet another method of making the MR composite 10, as shown in FIG. 7, a coil of electrically conducting material 13 is formed. The coil of electrically conducting material 13 is placed in a suitable mold. The mold is filled with a suitable quantity of elastomeric material 11. The elastomeric material is cured to embed the coil 13 within the elastomeric material. An axially extending opening is formed in a center of the coil by removing the elastomeric material. The opening is filled with a suitable elastomeric material having particles of magnetizable/polarizable material to form the MR composite 10.

FIG. 1 provides a top view of a MR composite 10 showing one suitable pattern of spacings of the shaped MR element 12 and conducting materials 13 embedded within the elastomeric matrix material 11.

In certain embodiments, the shaped MR elements 12 define a diameter that ranges from nominally about 0.1 nanometers to about 100 micrometers. The magnetic field generated in the shaped MR element 12 allows the stiffness of the whole composite 10 to be controlled as desired.

The magnetizable particles embedded within the shaped MR elements are aligned or oriented in a preferred arrangement and respond to an applied magnetic field, which, in turn, varies the stiffness and shear modulus properties of the composite 10. An increased amount of stiffness is achieved by increasing the applied current through the wires. In certain embodiments, when the wires 13 of the shaped MR elements 12 are spaced throughout the MR composite 10, only a very low level of applied current is needed in order to achieve the desired stiffness of the MR composite 10. It is to be understood that when the applied current is terminated, the MR composite 10 reverts to its pre-magnetized state, typically in milliseconds.

It is to be understood that as the applied electrical current increases the magnetic attractive forces between the particles is also increases, thereby altering the modulus characteristics of the MR composite 10.

It is to be understood that it is within the contemplated scope of the present invention that other patterns of wires and shaped MR elements can be used in the present invention. Although the invention has been described in detail with reference to a certain preferred embodiment, variations and modifications exist within the scope and spirit of the invention as described and defined in the following claims.

I claim:

1. A magnetorheological elastomer composite comprising
at least one elastomeric matrix material;
at least one magnetorheological element including: i) at least one magnetorheological (MR) elastomeric material having a plurality of magnetizable/polarizable particles dispersed therein, and, ii) at least one electrically conducting material at least partially wound around the at least one magnetorheological elastomeric material,
wherein the magnetorheological material is at least partially embedded in the elastomeric matrix material, and wherein the magnetorheological composite undergoes changes in stiffness when the magnetorheological element is subjected to a magnetic field.

2. The composite of claim 1, wherein the polarizable particles' diameter ranges from 0.1 nanometers to about 100 micrometers, and the magnetorheological shape element has a diameter that ranges from approximately 1 mm to approximately 10 mm.

3. The composite of claim 1, wherein a plurality of magnetorheological elements are embedded in the elastomeric matrix material.

4. The composite of claim 2, wherein a plurality of magnetorheological elements are embedded in the elastomeric matrix material in a suitable predetermined pattern.

5. The composite of claim 1, wherein the elastomeric matrix material comprises at least one elastomeric material and a suitable amount of polarizable/magnetizable particles.

6. The composite of claim 1, wherein the magnetorheological elements have a predetermined shape.

7. The composite of claim 1, wherein elastomeric material comprises at least one of a suitable gel or an elastomer of natural rubber (comprising polyisoprene), silicone, polybutadiene, polyethylene, styrene butadiene rubber (SBR), nitrile rubber, polychloroprene, polyisobutylene, synthetic polyisoprene, and blends thereof.

8. The composite of claim 1, wherein the manetorheological particles comprise at least one which is polarizable or magnetizable by means of an applied magnetic field.

9. The composite of claim 1, wherein the magnetorheological particles have paramagnetic, ferrimagnetic, or ferromagnetic properties.

10. The composite of claim 8, wherein the particles comprise at least one of oxides, chlorides, sulfates, sulfides, hydrates, and other organic or inorganic compounds of cerium, chromium, cobalt, dysprosium, erbium, europium, gadolinium, holmium, iron, manganese, neodymium, nickel, praseodymium, samarium, terbium, titanium, uranium, vanadium, and yttrium.

11. The composite of claim 8, wherein the particles comprise at least one of paramagnetic elements and alloys include gadolinium, various stainless steels and other alloys of iron, nickel, manganese, and cobalt, with or without other non-magnetic elements.

12. The composite of claim 8, wherein the ferrimagnetic particulates include at least one of magnetite (Fe₃O₄), other compounds of iron and oxygen, and, optionally, a third metallic component.

13. The composite of claim 8, wherein at least one of the ferromagnetic materials include iron, nickel, and cobalt, as well as alloys of these and other materials.

14. An article comprising
at least one elastomeric matrix material;
at least one magnetorheological element including: i) at least one magnetorheological (MR) elastomeric material having a plurality of magnetizable/polarizable particles dispersed therein, and, ii) at least one electrically conducting material at least partially wound around the at least one magnetorheological elastomeric material,
wherein the magnetorheological material is at least partially embedded in the elastomeric matrix material, and wherein the magnetorheological composite undergoes changes in stiffness when the magnetorheological element is subjected to a magnetic field.

15. The article of claim 1, wherein the magnetorheological elastomeric element has a diameter that ranges from approximately 1 mm to approximately 10 mm.

16. The article of claim 1, wherein a plurality of magnetorheological elements are embedded in the elastomeric matrix material.

17. The article of claim 15, wherein a plurality of magnetorheological elements are embedded in the elastomeric matrix material in a suitable predetermined pattern.

18. The article of claim 1, wherein the elastomeric matrix material comprises at least one elastomeric material and a suitable amount of polarizable/magnetizable particles.

19. The article of claim 1, wherein the magnetorheological elements have a predetermined shape.

20. The article of claim 1, wherein elastomeric material comprises at least one of a suitable gel or an elastomer of natural rubber (comprising polyisoprene), silicone, polybutadiene, polyethylene, styrene butadiene rubber (SBR), nitrile rubber, polychloroprene, polyisobutylene, synthetic polyisoprene, and blends thereof.

21. The article of claim 1, wherein the magnetorheological particles comprise at least one which is polarizable or magnetizable by means of an applied magnetic field.

22. The article of claim 1, wherein the magnetorheological particles have paramagnetic, ferrimagnetic, or ferromagnetic properties.

23. The article of claim 21, wherein the particles comprise at least one of oxides, chlorides, sulfates, sulfides, hydrates, and other organic or inorganic compounds of cerium, chromium, cobalt, dysprosium, erbium, europium, gadolinium, holmium, iron, manganese, neodymium, nickel, praseodymium, samarium, terbium, titanium, uranium, vanadium, and yttrium.

24. The article of claim 21, wherein the particles comprise at least one of paramagnetic elements and alloys include gadolinium, various stainless steels and other alloys of iron, nickel, manganese, and cobalt, with or without other non-magnetic elements.

25. The article of claim 21, wherein the ferrimagnetic particulates include at least one of magnetite (Fe₃O₄), other compounds of iron and oxygen, and, optionally, a third metallic component.

26. The article of claim 21, wherein at least one of the ferromagnetic materials include iron, nickel, and cobalt, as well as alloys of these and other materials.

27. The article according to claim 14, useful as an automotive component.

28. A method of making a magetorheological elastomeric composition comprising winding a suitable length of an electrically conducting material at least partially around at least one magnetorheological elastomer element and embedding the wound magnetorheological elastomer element within an elastomeric matrix material.

29. The method of claim 28, in which the at least one magnetorheological (MR) element comprises of at least one elastomeric material and a plurality of magnetorheological (MR) particles.

30. A method of making a magnetorheological elastomeric composite comprising: i) forming at least one suitable precursor MR elastomeric material comprising at least one type of elastomeric material and at least one type of magnetizable particles into a shaped MR material; ii) at least partially surrounding the shaped MR material with an electrically conducting material to form a MR element; and iii) positioning the MR element within an opening in an elastomeric matrix material.

31. A method of making a magnetorheological composite comprising: i) forming a coil of at least one electrically conducting material; ii) placing the coiled electrically conducting material in a suitable mold which has desired dimensions; iii) filling the mold with a suitable elastomeric material containing particles of magnetizable/polarizable material; and iv) curing the elastomeric material with the coiled electrically conducting material, thereby embedding the coiled electrically conducting material within the elastomeric material.

32. A method of making a magnetorheological composite comprising: i) forming a coil of at least one electrically conducting material; ii) placing the coil of electrically conducting material in a suitable mold; iii) filling the mold with a suitable quantity of at least one elastomeric material; iv) curing the elastomeric material to embed the coil within the elastomeric material; forming an axially extending opening in a center of the coil by removing the elastomeric material; and v) at least partially filling the opening with a suitable elastomeric material having particles of magnetizable/polarizable material.
